(19) United States
(12) Patent Application Publication
(10) Pub. No.: US 2017/0181385 A1
(43) Pub. Date: Jun. 29, 2017

(54) STACKABLE AND TIERED MODULAR KIT, ASSEMBLY AND METHOD INCLUDING A PLURALITY OF HOOP SHAPED COMPONENTS FOR SUPPORTING A STEM OF A GROWING PLANT

(71) Applicant: Kevin M. Daniel, Port Huron, MI (US)

(72) Inventor: Kevin M. Daniel, Port Huron, MI (US)

(21) Appl. No.: 15/385,413

(22) Filed: Dec. 20, 2016

Related U.S. Application Data
(60) Provisional application No. 62/272,563, filed on Dec. 29, 2015.

(51) Int. Cl. A01G 9/12; A01G 9/02

(52) U.S. Cl. CPC A01G 9/122; A01G 9/02

(57) ABSTRACT

A kit for providing stem, branch and foliage support for a planting. The kit includes a plurality of hoop shaped components, each exhibiting an open interior adapted to support and constrain therebetween the planting. The components each further exhibit a plurality of vertically extending and elongated tier defining portions arranged in perimeter defined fashion about the component, with an intermediate location of each of an individual plurality of said tier defining portions being integrated into each of the hoop components. Each of the elongated tier defining portions further has upper and lower inter-engaging locations and, upon supporting a lower-most hoop shaped component proximate a base of the planting, allowing for stacking of any additional number of said hoop shaped components in vertically spaced apart and tiered defining fashion.

### CROSS REFERENCE TO RELATED APPLICATIONS

The present application claims the priority of U.S. Ser. No. 62/272,563 filed Dec. 29, 2015, the contents of which are incorporated herein in its entirety.

### FIELD OF THE INVENTION

The present invention relates generally to a modular plant support kit, assembly and method of assembly. More particularly, the present invention teaches such a kit, assembly and method incorporating a plurality of hoop shaped components which can be arranged in vertically ascending/tiered fashion in order to support the stem of a growing plant.

### BACKGROUND OF THE INVENTION

The prior art is documented with various examples of stackable or module plant support structures. The purpose of such structures or assemblies is to provide a vertically ascending or tiered support to a growing plant stem.

A first example from the prior art is described in U.S. Pat. No. 8,567,120, to Davis et al., which teaches a modular support for vine plants and tomato plants having a solid, cylindrical base with holes to accept posts and associate tier rings. A cover may also be provided to transform the base into a miniature hot house. Notches may be formed in the rim of the base to accommodate irrigation systems and stake ends may be provided for the posts to allow immediate securement of the posts to the ground rather than the base. The solid base contains water, mulch and other beneficial compounds for the plants and helps block the spread of weeds immediately around the plant. As the plant grows, additional tiers may be added to the support to increase its size. The parts are preferably made of a durable plastic so as to support larger plants and increase longevity of the support.

A second example is shown in Wilbanks, Jr. et al., U.S. Pat. No. 7,478,501, which teaches a modular plant support system for supporting growing plants made up of a stacked interlocking layers of cylindrical split rings. The split rings are flexible and modular and configured to interconnect end to end so as to form a plant support layer of any reasonable diameter by coupling multiple sections. The layers of the plant support stand may be stacked and interconnected to form a plant support system of a height suited to support requirements of the plant.

Elliott, U.S. Pat. No. 5,640,802, teaches a support assembly for growing tomato plants which allows ready access to the plant during the various stages of growth by utilizing interchangeable parts. These include post sections having a tapered member (A) on a bottom end and a tapered socket (B) on the other end for joining the sections to form continuous posts having vertically spaced seating locations (C), and horizontal supports (D) having sockets (E) which fit securely onto post sections and spaced vertically to form modules that may be stacked in vertical relation and thereby added progressively to meet the needs engendered by growth of the plant and to permit ready access to the plant.

Brown, US 2015/0113869, teaches a plant growing system which protects plants during spring, for early and/or fast growth, and supports the plants later in the growing season. Frames hold panels that protect the plants by enclosing, shielding, and/or shading the interior growing space, and upon removal of the panels, the frames may support the larger plants and their fruit/vegetables. Multiple cooperating frames pivotally connect to form modular units of various sizes and shapes, and a latching/locking feature may stabilize the unit by preventing accidental disconnection of the frames. The frames may include feature(s) that allow, and stabilize, stacking of multiple units for accommodating taller plants. The panels held by the frames may be translucent/transparent, opaque, or a combination of the two, for customizing the interior environment inside each modular unit to the plant(s), the time of year, and/or the location and climate.

### SUMMARY OF THE INVENTION

The present invention teaches a kit and assembly incorporating a plurality of hoop shaped components for supporting a stem of a plant. Each of the hoop shaped components exhibits a plurality of vertically integrated and elongated tier defining portions arranged in perimeter defined fashion about the hoops, an intermediate location of each of an individual plurality of tier defining portions being integrated into each hoop.

The tier defining portions each exhibit upper and lower inter-engaging locations for stacking any plurality of hoop shaped components in vertically spaced apart and tiered defining fashion. Optional elongated and height extending portions can be interposed between the integrated tier defining portions in order to increase the vertical spacing between respective hoop shaped components.

Each of the hoop shaped components can include a disk shape with an inner perimeter rim edge, and so that a lower-most hoop component can be configured to engage an upper rim location of a plant supporting bucket in a first supporting arrangement. A plurality of feet stakes are provided and, in a second mounting arrangement, can engage the lower engaging locations associated with the bottom most tiered hoop shaped component, the feet stakes being further adapted to embed in a soil location associated with a field or garden planted stem.

An additional variant includes recessed profiles, or scallops, configured at perimeter spaced intervals about the exterior of each ring. The outer scalloped configuration permits for more compact and higher density storage of the hoop shaped components. A method of assembly is also provided and utilizes the disclosed structure in order to provide for both assembled use and compact storage configurations.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an exploded view of the kit and assembly according to a first variant and which includes a selected hoop shaped component which exhibits a plurality of vertically integrated and elongated tier defining portions arranged in perimeter defined fashion about the hoop, as well as showing elongated and height extending portions interposed between the integrated tier defining portions in order to increase the vertical spacing between respective hoop shaped components and feet stakes engageable with lowermost engaging locations associated with the bottom most tiered hoop shaped component;

FIG. 2 is a front plan view of the exploded embodiment of FIG. 1 and further illustrating, in phantom, a plant bucket having an upper rim location to which a lower-most hoop component can be configured to engage in a further supporting arrangement not requiring the feet stakes;

FIG. 3 is a top plan view of the embodiment of FIGS. 1-2 and illustrating the height extending portions and feet stakes positionally radially outwardly from the perimeter of the hoop shaped component for purposes of clarity of presentation;

FIG. 4 is a ninety degree rotated side plan view of the exploded embodiment of FIG. 2;

FIG. 5 is a bottom plan view of the embodiments of FIGS. 1-4;

FIG. 6 is an assembled perspective view of the modular kit and assembly according to a further variant without use of the intermediate spacers;

FIG. 7 is an exploded perspective view of the kit and assembly shown in FIG. 6;

FIG. 8 is an assembled front plan view of variant of FIG. 6;

FIG. 9 is an assembled perspective view of the modular kit and assembly according to the variant of FIG. 1 with a second tier defining hoop shaped component;

FIG. 10 is an exploded perspective of FIG. 9;

FIG. 11 is a plan view illustration of FIG. 10;

FIG. 12 is a perspective of a further variant of hoop-shaped component exhibiting a partially open profile; and

FIG. 13 is an exploded perspective view similar to FIG. 7 of a plurality of interconnecting components as shown in FIG. 12 and in which the partially open profiles of each hoop shaped component are circumferentially offset or staggered to maintain vertical support about the foliage base, stem and branches;

FIG. 14 is an exploded view similar to FIG. 1 of a kit and assembly according to a second variant which is otherwise identical to that previously depicted with the exception of a plurality of exteriorly configured and circumferentially offset scalloped surfaces configured in circumferentially spaced fashion about an exterior periphery of the hoop shaped component;

FIG. 15 is a front plan view of the exploded embodiment of FIG. 14 and further again illustrating, in phantom, a plant bucket having an upper rim location to which a lower-most hoop component can be configured to engage in a further supporting arrangement not requiring the feet stakes, as well as depicting from a side profile the scalloped exterior recesses configured in the hoop shaped component;

FIG. 16 is a top plan view of the embodiment of FIGS. 14-15 and illustrating the hoop shaped component with outer scalloped/recessed locations for purposes of clarity of presentation;

FIG. 17 is a succeeding top view to FIG. 16 and depicting a plurality of hoop shaped components in a stored and stacked arrangement, and in which the vertically extending intermediate and integrated portions of each defined tier is shown seated within a plurality of circumferentially offset receiving scalloped surfaces of a succeeding hoop shaped component; and

FIG. 18 is a perspective view of the multi-tiered stacked storage configuration of FIG. 17.

### DETAILED DESCRIPTION OF THE PREFERRED EMBODIMENTS

As will be described with reference to the appended illustrations, the present invention teaches a kit and assembly incorporating a plurality of hoop shaped components for supporting a stem of a plant. The kit can be reconfigured in a number of different ways in order to provide constraining support to the stem, branches and foliage of a growing planting (generally identified to include any of a tree, shrub or plant). The modular nature of the kit is further such that it can be easily tiered or stacked in order to track the growth of the planting, and for as long as is necessary to provide the desired degree of support.

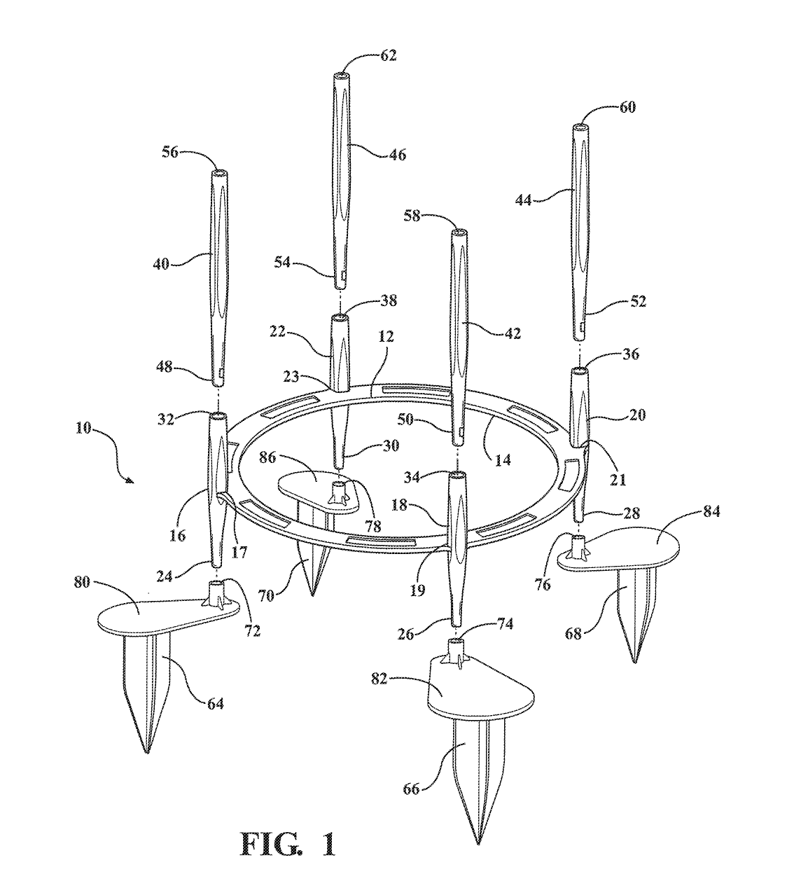

FIG. 1 is an exploded view, generally at 10, of the kit and assembly according to a first variant and which includes a selected hoop shaped component 12 which, as shown, exhibits a generally circular shape and can, without limitation, be constructed of a durable thermoplastic material (e.g. such as by a suitable injection molding operation), it being further understood that the individual components can be constructed of any other suitable material providing the necessary characteristics and not limited to plastics or metals. The hoop shaped component 12 can further have any polygonal or closed inner facing profile (see surface 14) and may also exhibit flexural properties.

A plurality of vertically integrated and elongated tier defining portions, see four such portions at 16, 18, 20 and 22, are arranged in perimeter defined and integrated fashion about the hoop shaped component 12, such that an intermediate extending portion or location (see at 17, 19, 21 and 23, respectively) of each tier defining portion is molded or otherwise affixed to such as an outer surface of the hoop shaped component. Without limitation, any sub-plurality of such tier defining portions (two, three, five, etc.) can be provided for each hoop shaped component, these being identically configured in order to provide for modularized stack-ability in order to arrange any number of hoop shaped components in a tiered fashion to maintain a desired supporting arrangement for the growing planting.

The vertically integrated and elongated portions 16, 18, 20 and 22 each further include upper and lower inter-engaging ends, these illustrated in non-limiting example by lower male inserting portions 24, 26, 28 and 30, as well as by upper female socket receiving portions 32, 34, 36 and 38. It is further envisioned and understood that any other interlocking arrangement (such as including tab and slot or other) can be established between the respective upper and lower mounting ends of each tier defining portion without limitation.

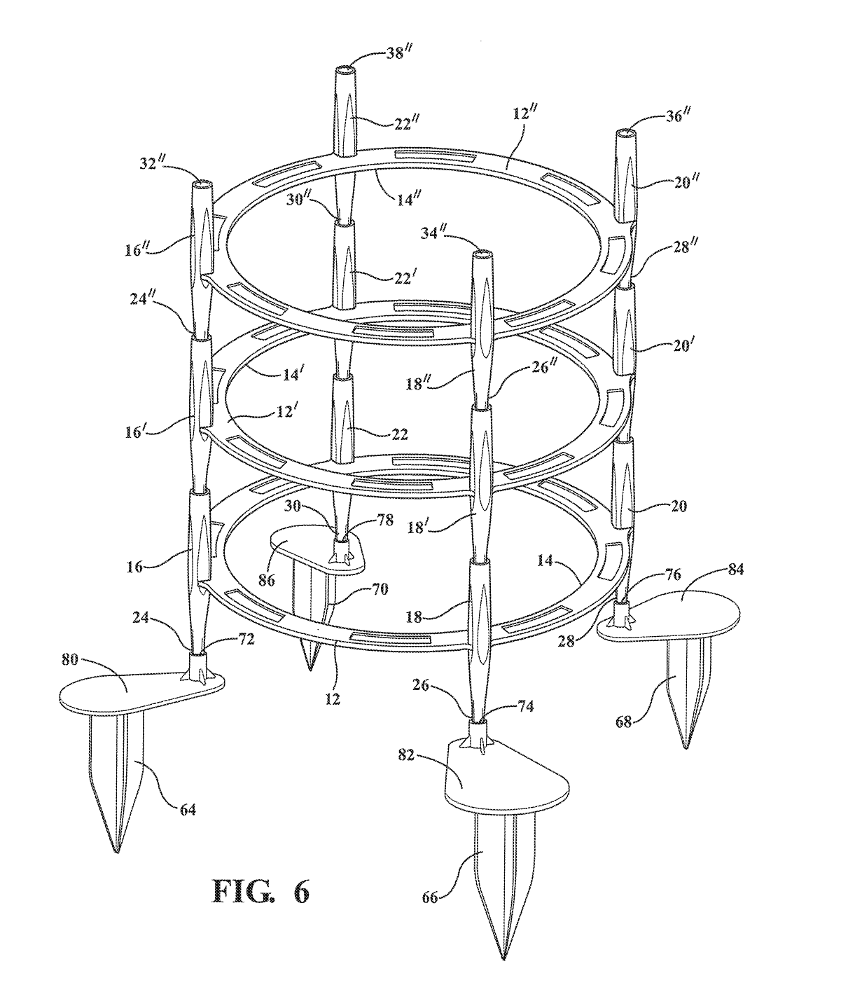

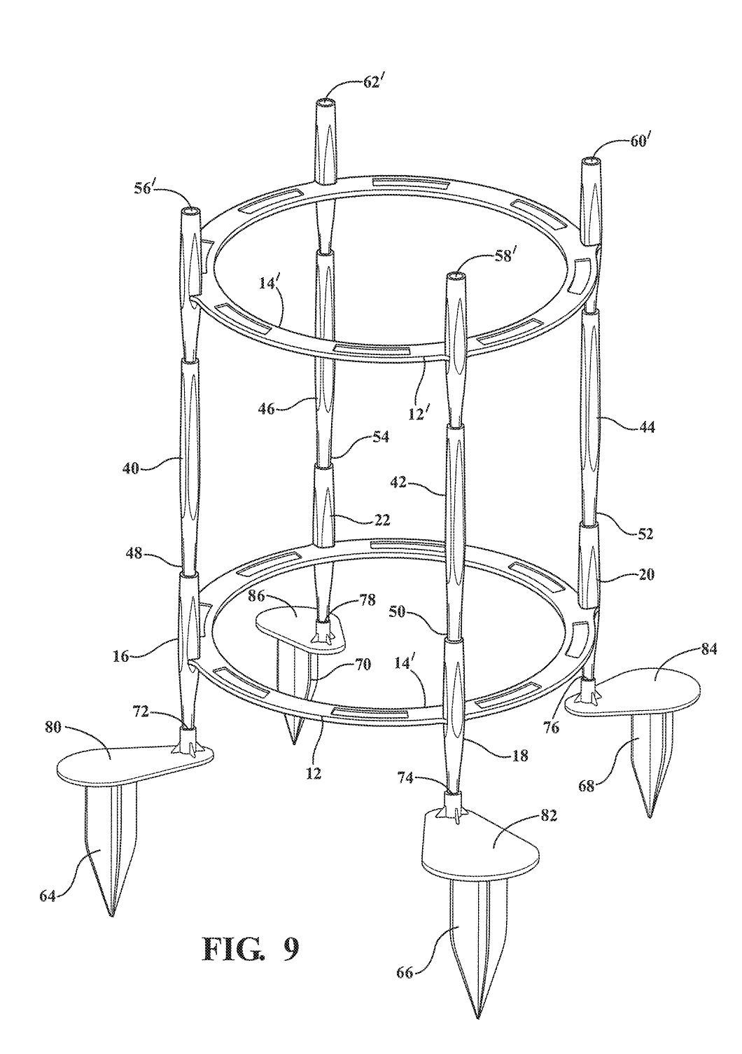

As will be illustrated with reference to the additional drawings, the hoop shaped components can be directly stacked atop one another in multi-tiered fashion (see FIGS. 6-8). As further shown in FIG. 1, an alternate variant includes the provision of a plurality of elongated and height extending portions, see at 40, 42, 44 and 46, interposed between successive aligning and integrated tier defining portions (this shown in FIGS. 9-11) associated with successive and identically configured hoop shaped components, this in order to increase the vertical spacing between respective hoop shaped components.

The height extending portions 40, 42, 44 and 46 can exhibit any circular or polygonal cross sectional profile (see perspective configuration in FIG. 1 with circumferentially offset details 41, 43, 45 and 47 in FIG. 1), and each include lower end disposed inter-engaging portions (e.g. male inserting portions 48, 50, 52 and 54), as well as upper end disposed female socket portions (at 56, 58, 60 and 62), and so that the height extending portions inter-fit with the inter-engaging ends of the respective tier defining portions. The lower end portions can also include additional details, see at 57, 59, 61 and 63 in FIG. 1, which can provide additional frictional inter-fitting within the receiving interiors of the upper female socket receiving portions 32, 34, 36 and 38 of the vertically integrated portions 16, 18, 20 and 22.

A first mounting arrangement for a lower most positioned hoop shaped component 12 (again FIG. 1) is further provided by a plurality of feet stakes 64, 66, 68 and 70, these corresponding in number to the given plurality of tier defining portions integrated into the hop shaped component. As shown, the feet stakes can each include an upper end receiving socket (at 72, 74, 76 and 78 respectively) engageable with the lowermost engaging locations (male lower ends 24, 26, 28 and 30) associated with the bottom most tiered hoop shaped component.

Without limitation, the feet stakes 64, 66, 68 and 70 depicted include a flattened intermediate planar surface (at 80, 82, 84 and 86) which separate the lower projecting spike locations (again shown at 64-70) from the upper disposed receiving sockets 72-78. In this fashion, the planar surfaces can provide ease of press embedding (such as by the user's foot) into the turf location associated with a field or garden in which the desired planting is located. It is also understood that the feet stakes can exhibit any other desired shape or configuration without limitation and is understood to not be limited to that depicted herein.

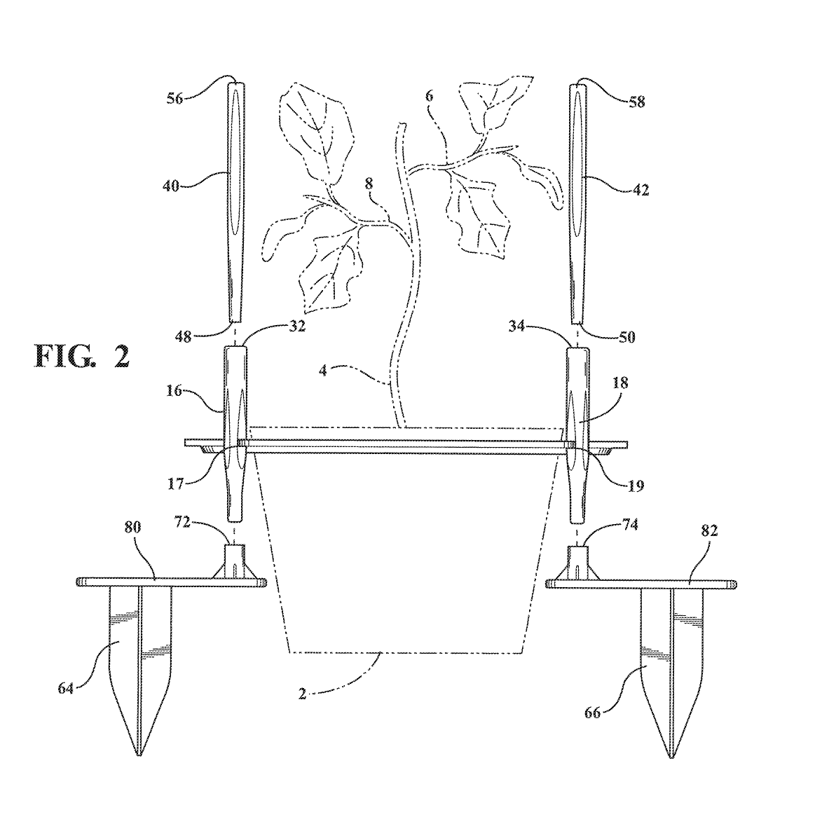

As further shown in corresponding FIG. 2, each of the hoop shaped components can include a disk shape with its inner perimeter rim edge 14 associated with a lower-most hoop component configured to engage a plant bucket 2, illustrated in phantom, the plant bucket having an upper rim location to which the lower-most hoop component can be configured to engage in a further supporting arrangement not requiring the feet stakes. As further shown in FIG. 2, the stem 4 and branches/foliage (collectively referenced at 6 and 8) extend upwardly from the bucket 2 (or ground location) and which are constrained by the tiered hoop shaped components.

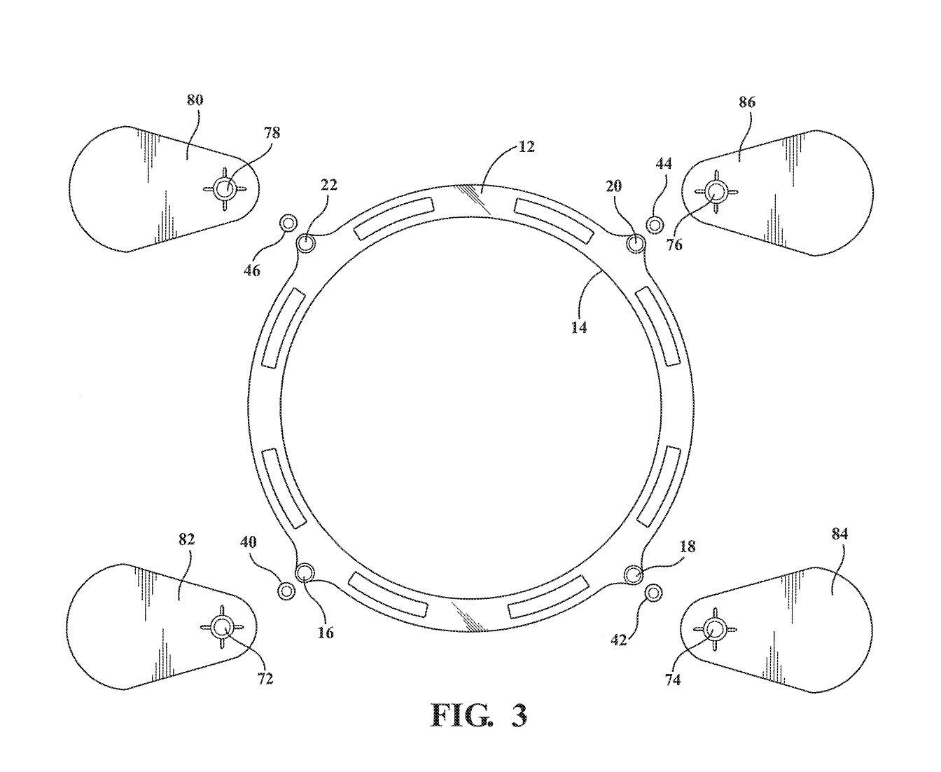

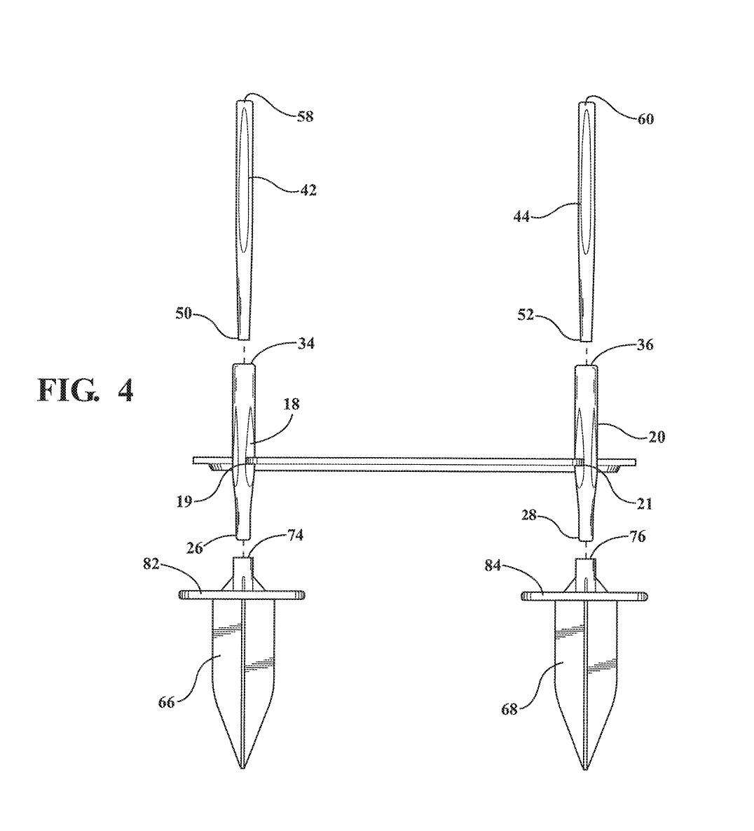

FIG. 3 is a top plan view of the embodiment of FIGS. 1-2 and illustrating the height extending portions and feet stakes positionally radially outwardly from the perimeter of the hoop shaped component for purposes of clarity of presentation. FIG. 4 is a ninety degree rotated side plan view of the exploded embodiment of FIG. 2.

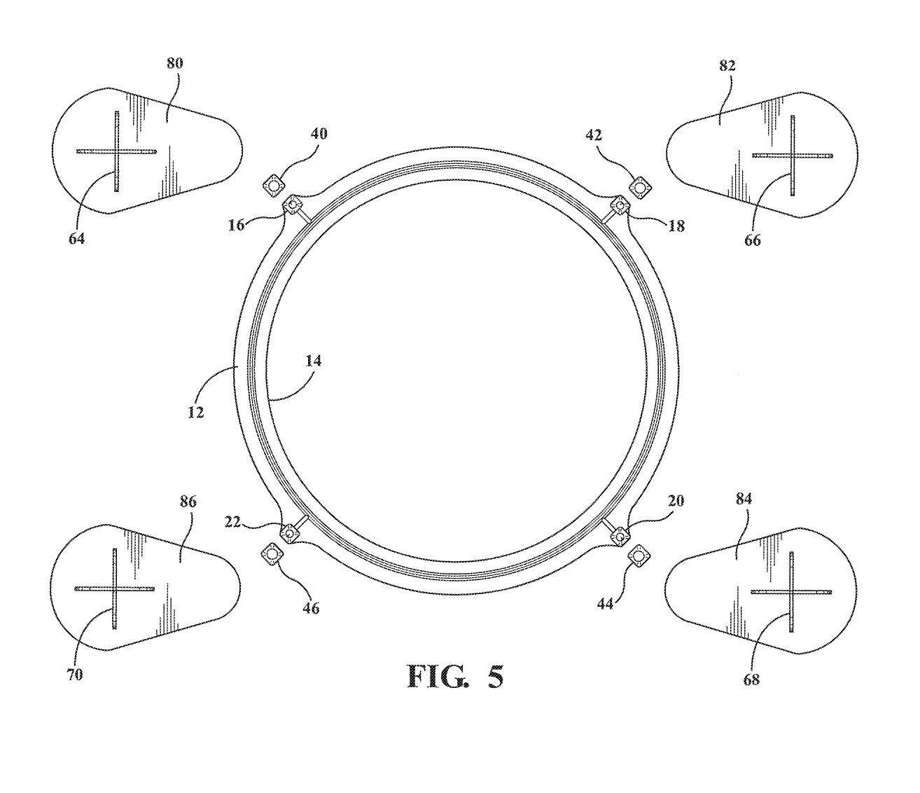

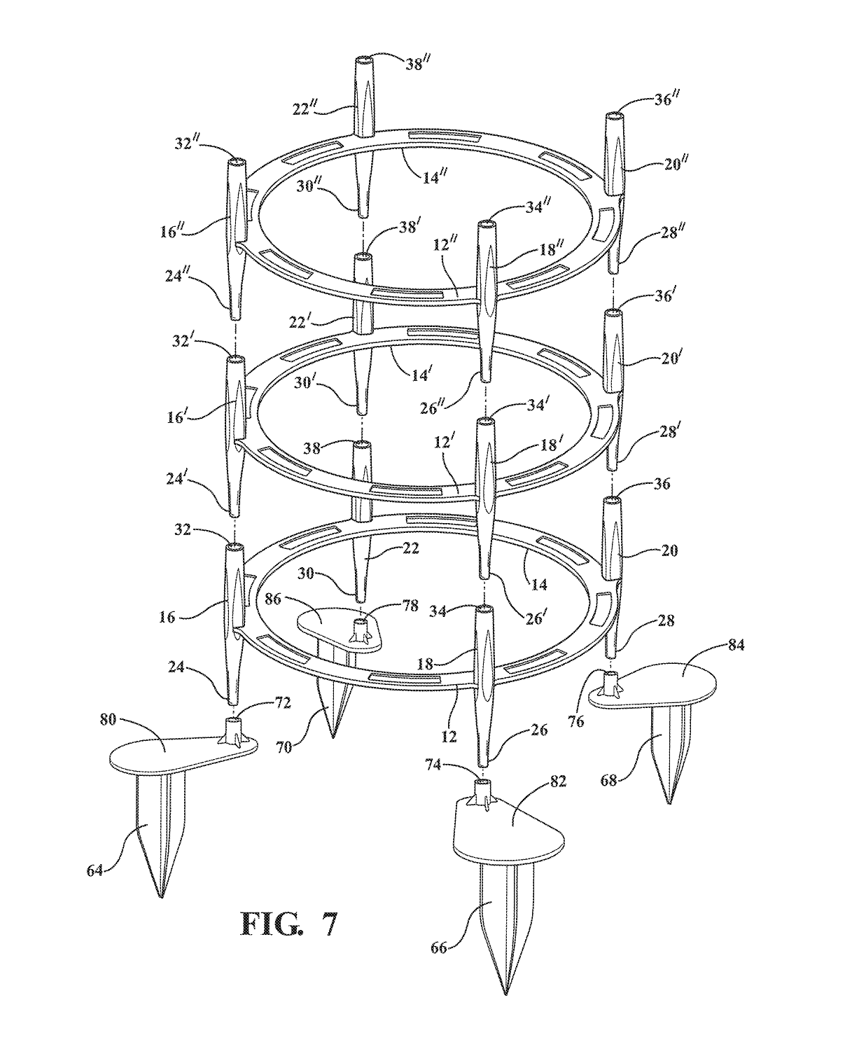

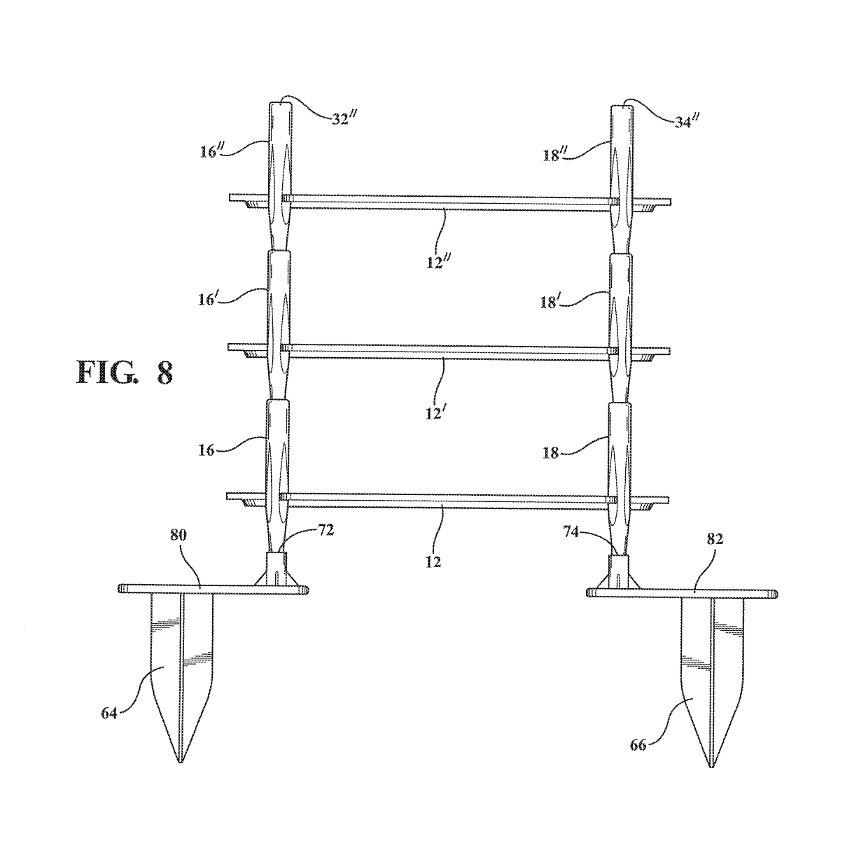

FIG. 5 is a bottom plan view of the embodiments of FIGS. 1-4 and better showing the optional square cross sectional profile associated with the intermediate location of each tier defining portions 16-22 and length extending portion 40-46. FIG. 6 is an assembled perspective view of the modular kit and assembly according to the variant for directly stacking the hoop shaped components one atop another and without use of the intermediate spacers, with FIG. 7 an exploded perspective view of the kit and assembly shown in FIG. 6 and FIG. 8 an assembled front plan view. For purposes of the illustrations, additional tiered hoop shaped components 12′ and 12′ are referenced, along with identical nomenclature associated with the respective identical features of each additional component.

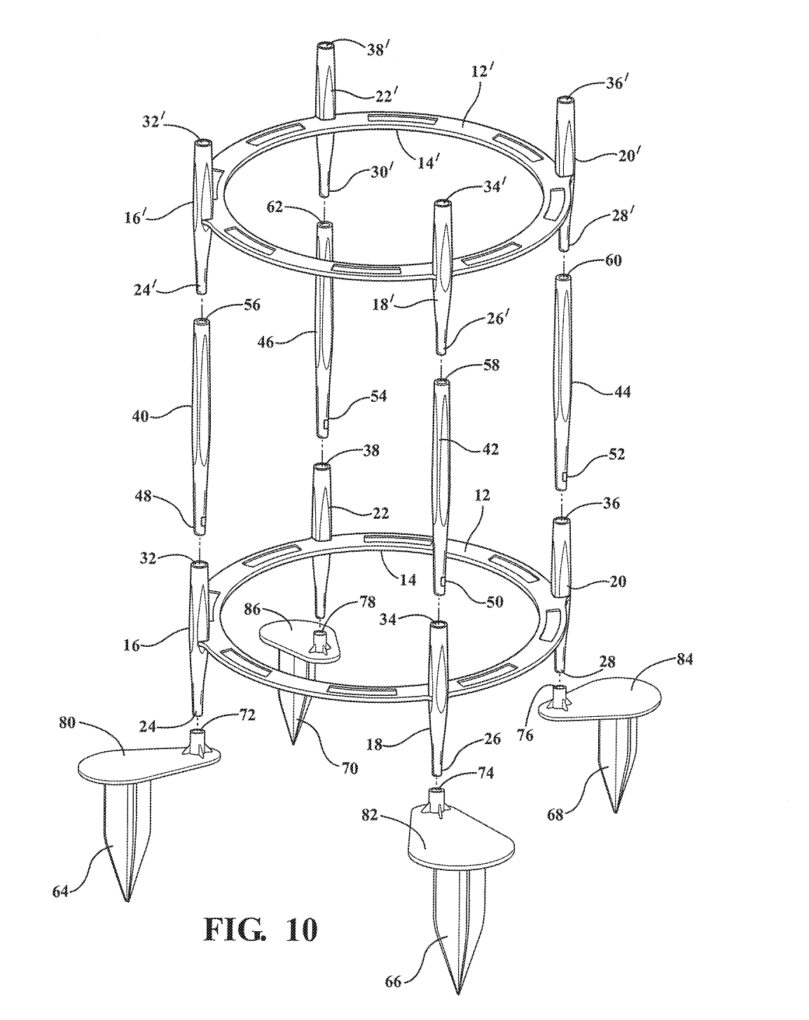

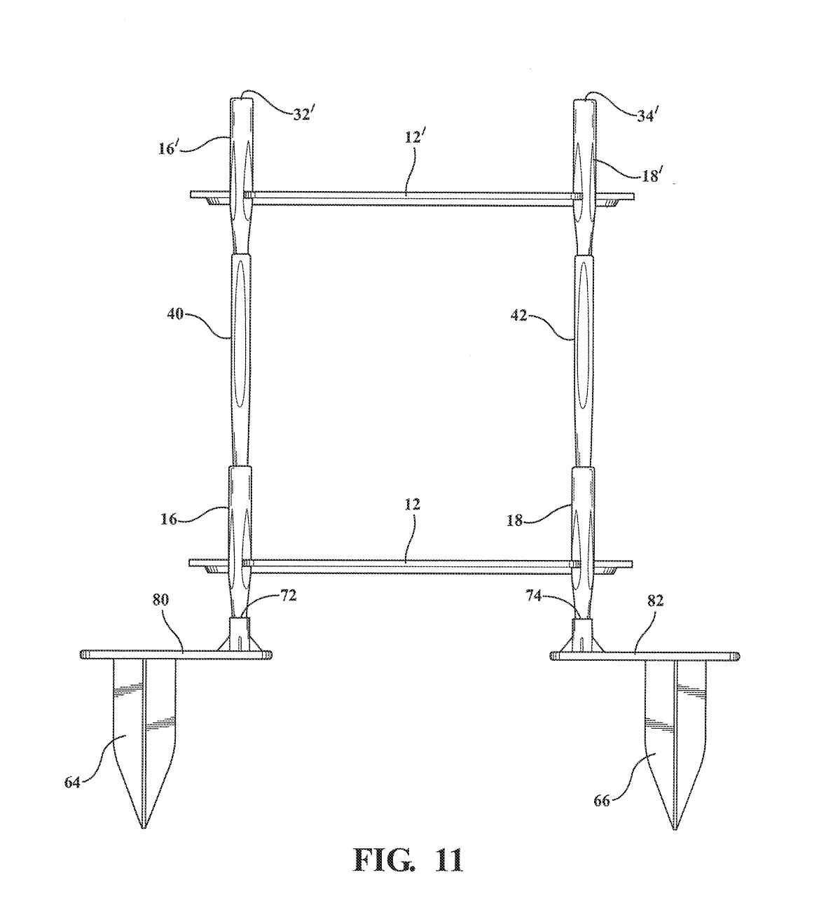

FIG. 9 is an assembled perspective view of the modular kit and assembly according to the variant of FIG. 1 with a second tier defining hoop shaped component. FIG. 10 is an exploded perspective of FIG. 9 and FIG. 11 a plan view illustration of FIG. 10, with the numbering of hoop shaped components 12 and 12′ repeated.

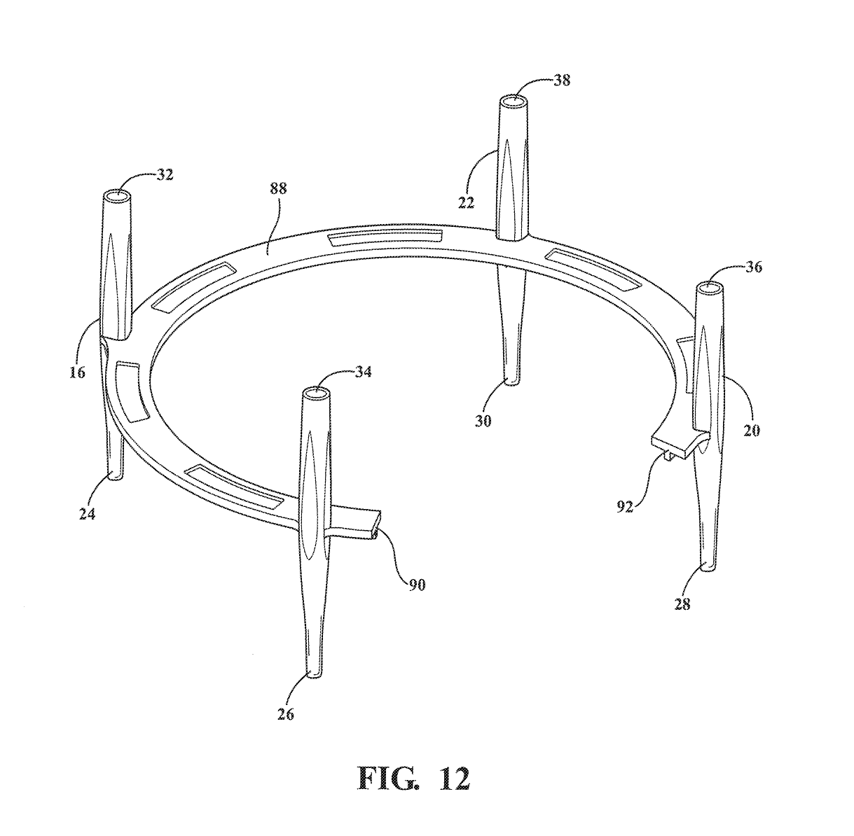

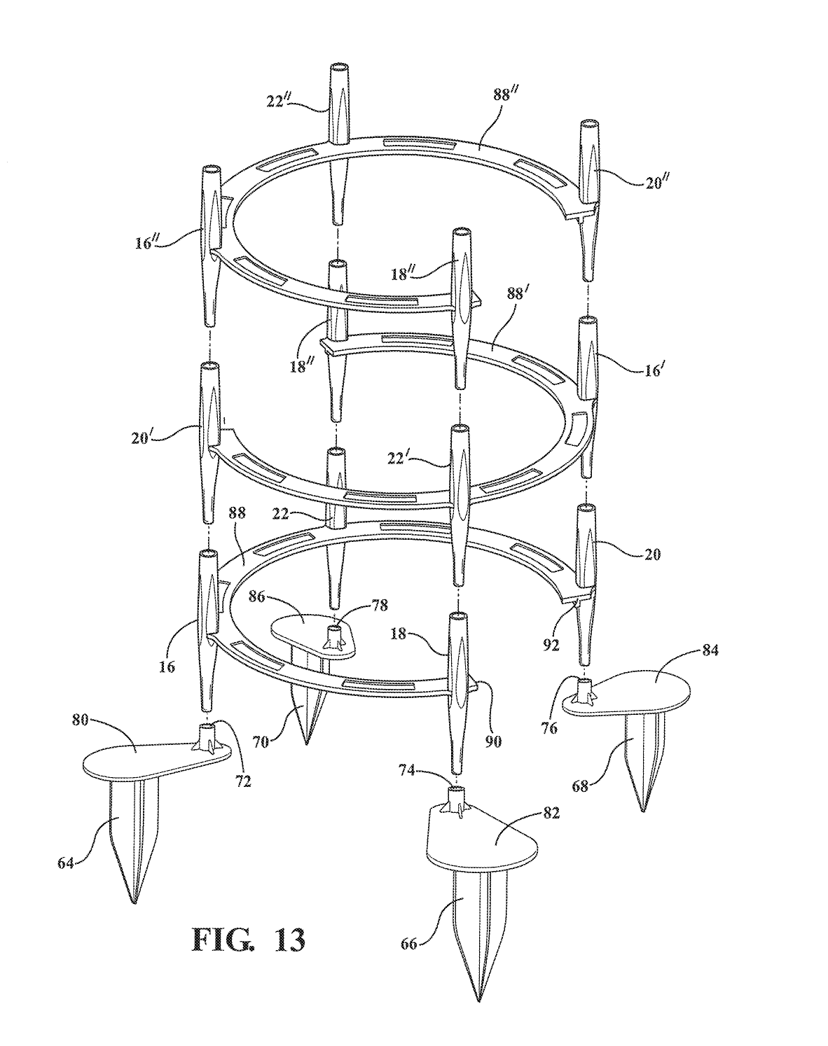

FIG. 12 is a perspective of a further variant of hoop-shaped component 88 exhibiting a partially open profile exhibited by opposing and circumferentially spaced gap or split surfaces 90 and 92, which therebetween define an open spacing in the perimeter extending hoop (the split location further revealing at 92 an underside projecting or reinforcing rib which can add strength to the open defining edges of the ring 88). FIG. 13 further provides an exploded perspective view similar to FIG. 7 of a plurality of interconnecting components as shown in FIG. 12, the assembly and operation of which is otherwise unchanged.

As further shown in FIG. 13, the hoop components 88, 88′, 88″, et seq. can be stacked so that the gaps in the hoops can align (such as to more easily facilitate removal of a planting without disassembly of the support. Alternately and as further shown, the hoop shaped components 88, 88′, 88″ can be alternated (i.e. circumferentially offset or staggered) in some fashion so that the gaps in the components are not aligned. Otherwise, the remaining features, including the elongated tier defining portions, the height extending portions (not shown) and the feet supports are repeated from the previous embodiments and are identically numbered.

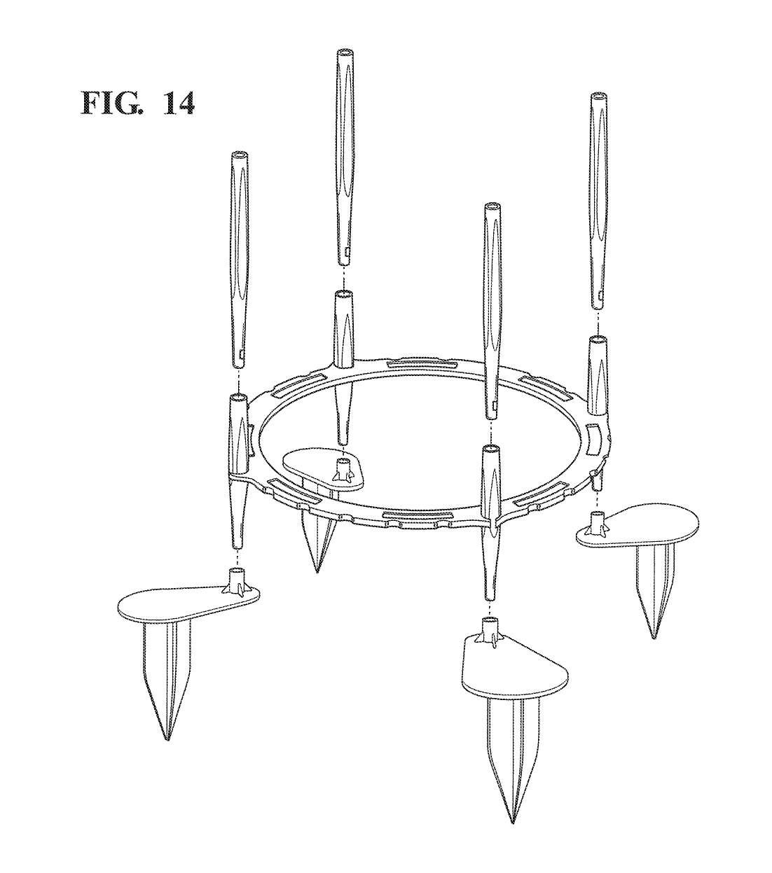

With reference to FIGS. 14-18, a series of illustrations are shown of a second variant of hoop shaped component 112 with inner rim edge 114 integrated into a modified kit and assembly 10′. With the exception of the exteriorly configured scalloped recesses designed into each of the hoop shaped components, the remaining features of the kit and assembly are substantially identical to those depicted in the first embodiment 10 and throughout FIGS. 1-13, except that the integrated vertical portions 16, 18, 20 and 22 of FIG. 1 and likewise renumbered as 116, 118, 120 and 122 in FIGS. 14-18. Other identical features are repetitively numbered without additional description.

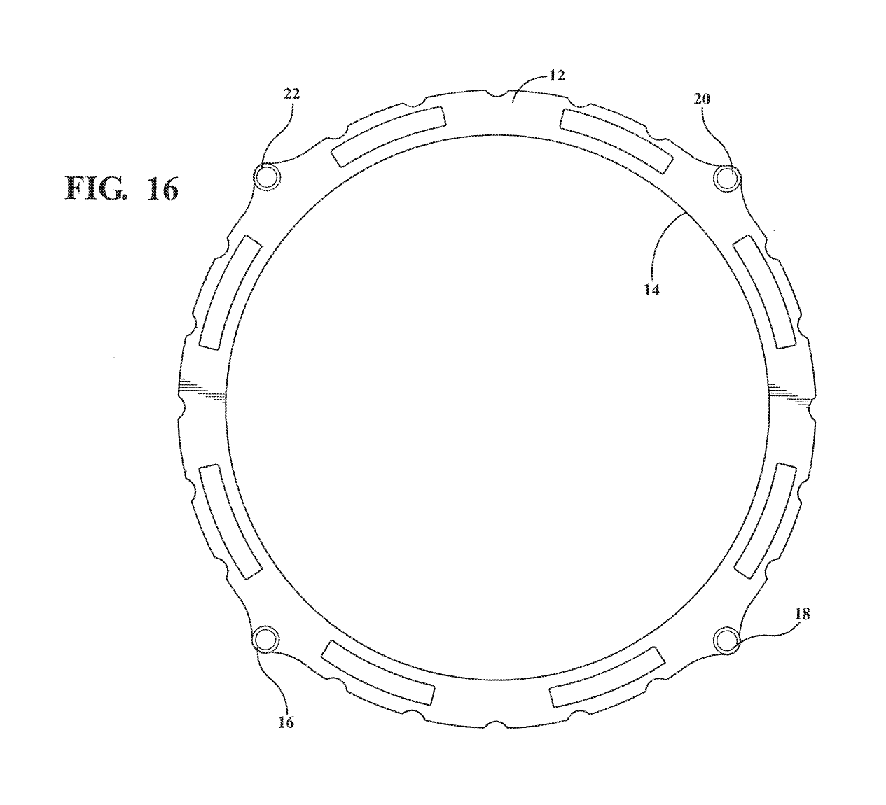

Referring initially to FIG. 14, an exploded view similar to FIG. 1 of a kit and assembly according to a second variant which is otherwise identical to that previously depicted with the exception of a plurality of exteriorly configured and circumferentially offset scalloped surfaces configured in circumferentially spaced fashion about an exterior periphery of the hoop shaped component. In combination with the top plan view of FIG. 16, the scalloped recess configurations each include a plurality of circumferentially offset or staggered concave or arcuate recess profiles.

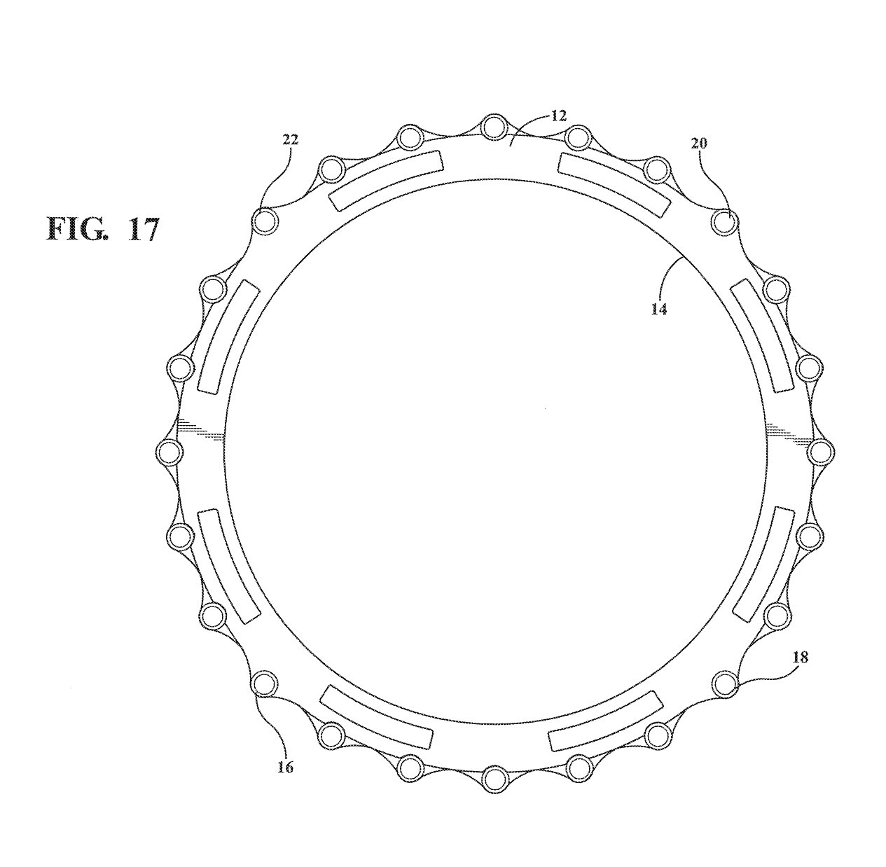

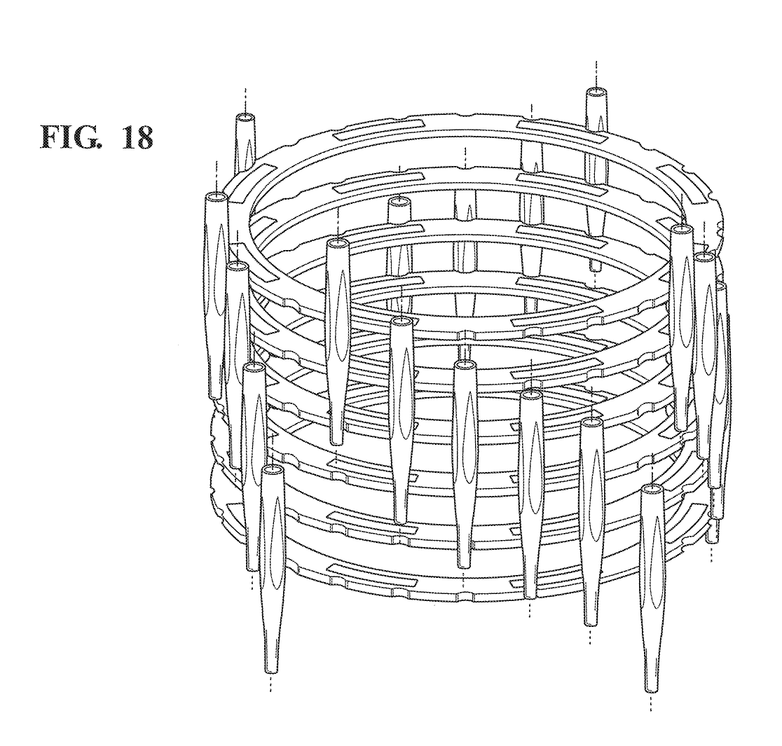

As shown, the scalloped recess profiles are depicted in circumferentially offset (and typically equidistantly spaced) sub pluralities at 124, 126, 128, 130 and 132, between vertical integrated height extending portions 116 and 118; at 134, 136, 138, 140 and 142, between vertical integrated height extending portions 118 and 120; at 144, 146, 148, 150 and 152, between vertical integrated height extending portions 120 and 122; and at 154, 156, 158, 160 and 162, between vertical integrated height extending portions 122 and 116. As will be described and illustrated in FIGS. 17-18, the scalloped recesses provide for multi-tiered stored seating of a plurality of hoop shaped components and it is envisioned and understood that the shaping of the recesses can be modified to match those of the associating cross sectional profiles exhibited by the vertical integrated portions 116, 118, 120 and 122.

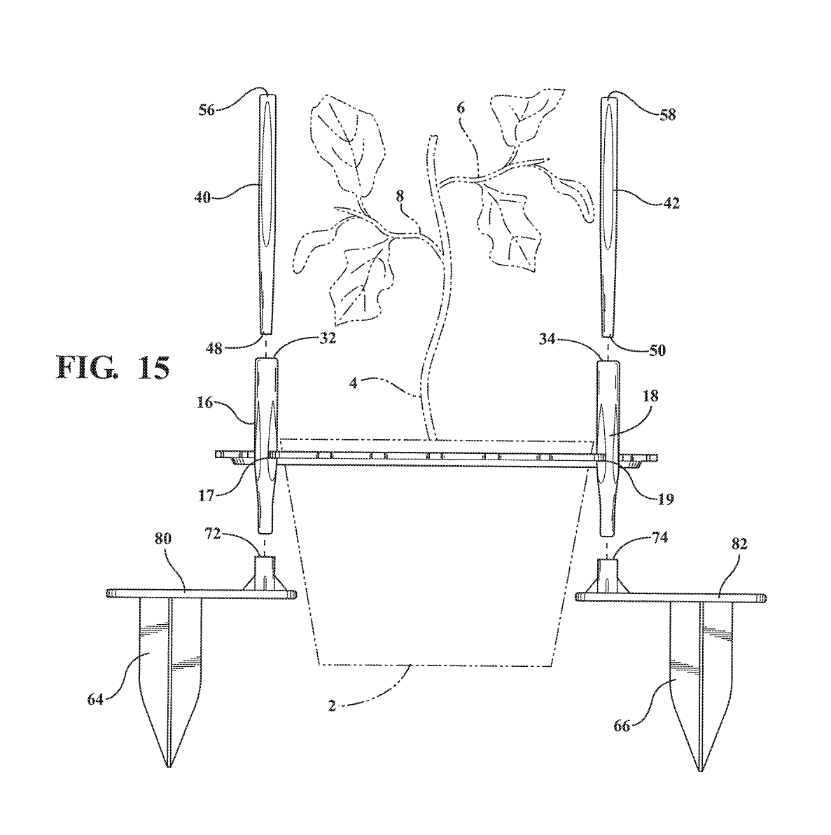

FIG. 15 illustrates a front plan view of the exploded embodiment of FIG. 14 and further again illustrating, in phantom, a plant bucket 2 having an upper rim location to which a lower-most hoop component can be configured to engage in a further supporting arrangement not requiring the feet stakes, as well as depicting from a side profile the scalloped exterior recesses configured in the hoop shaped component.

Proceeding to FIG. 17, a succeeding top view to FIG. 16 is again shown and depicting a plurality of hoop shaped components in a stored and stacked arrangement, and in which the vertically extending intermediate and integrated portions 116, 118, 120 and 122 of each defined tier is shown seated within a dedicated subset plurality of circumferentially offset receiving scalloped surfaces of a succeeding hoop shaped component. Viewing also the perspective view of FIG. 18 along with FIGS. 16 and 17, in combination, this illustrates a non-limiting embodiment in a multi-tiered stacked storage configuration of six hoop shaped components 112 can be stacked in a higher density storage and non-use configuration (see again FIG. 18).

Reconciling these illustrations, this includes the initial vertical integrated portions 116, 118, 120 and 122 of a top most positioned hoop 112 seating with scalloped portions 124, 134, 144, and 154 of an underneath spaced hoop 112. Proceeding on, the vertical portions of the second tier hoop then seat with further offset scalloped portions 126, 136, 146 and 156 of a third tiered hoop 116, and so on until the plurality of six hoops as best shown in FIG. 18 are stacked in the manner shown in order to complete the stacking arrangement. This arrangement is further represented in top plan view in FIG. 17 by succeeding offset vertical integrated portions associated with each hoop, these shown at 116/118/120/122 for uppermost hoop, 116′/118′/120′/122′ for second tier hoop, 116″/118″/120″/122″ for third tier hoop, 116′″/118′″/120′″/122′″ for fourth tier hoop, 116″″/118″″/120″″/122″″ for fifth tier hoop and, finally at 116′″″/118′″″/120′″″/122′″″ for bottom most or sixth tier hoop.

In this fashion, the intermediate integrated tier defining portions of each hoop are stacked atop one another in a manner which allows them to telescope past at least the lower positioned ring and in order to increase the density of stacking of the plurality of hoop shaped components (six shown in FIG. 18). It is also envisioned and understood that the number, spacing and dimension of the scalloped edges can be further modified as desired to accommodate any size, number or orientation of plural stacked hoop shaped components according to any storage (non use) configuration. The present invention further discloses an associated method for constructing a plurality of hoop shaped components in a manner which provides for elevating and modularly adjustable support to an extending foliage utilizing the above described structure.

Having described my invention, other and additional preferred embodiments will become apparent to those skilled in the art to which it pertains and without deviating from the scope of the appended claims. This can include the hook shaped and other height extending/ground engaging components also potentially including a pressed biodegradable material which can be placed in an outdoor environmental condition and potentially biodegrade or wear away over time concurrent with the growing and rooting of the foliage.

I claim:

1. A kit for providing stem, branch and foliage support for a planting, said kit comprising:
at least one hoop shaped component exhibiting an open interior adapted to encircle and support the planting;
each of said hoop shaped components exhibiting a plurality of vertically extending and elongated tier defining portions arranged in perimeter defined fashion about said component, an intermediate location of each of an individual plurality of said tier defining portions being integrated into each of said hoop components; and
each of said elongated tier defining portions further having upper and lower inter-engaging locations and, upon supporting a lower-most hoop shaped component proximate a base of the planting, allowing for stacking of any additional number of said hoop shaped components in vertically spaced apart and tiered defining fashion.

2. The kit as described in claim 1, further comprising elongated and height extending portions interposed between each of the integrated tier defining portions in order to increase the vertical spacing between said hoop shaped components.

3. The kit as described in claim 1, further comprising said lower-most hoop shaped component configured to engage an upper rim location of a planting supporting bucket.

4. The kit as described in claim 1, further comprising a plurality of feet stakes securing to lower inter engaging locations of said lower-most hoop shaped component, the feet stakes being further adapted to embed in a soil location associated with a field or garden planted stem.

5. The kit as described in claim 1, said upper and lower inter-engaging locations of each of said hoop integrated tier defining components further comprising male and female end configured portions.

6. The kit as described in claim 1, further comprising each of said hoop shaped components having flexural properties.

7. The kit as described in claim 1, said kit components being constructed of an injection molded thermoplastic material.

8. The kit as described in claim 1, each of said hoop shaped components further comprising opposing and circumferentially spaced split edges.

9. The kit as described in claim 8, said hoop shaped components further comprising an extending and reinforcing rib.

10. The kit as described in claim 1, each of said hoop shaped components further comprising a plurality of scalloped recessed edges in spaced apart fashion along an exterior perimeter edge such said the tier defining portions of each successively stacked hoop component are seated within an offset sub plurality of said recessed edges in order to provider denser stacking of said components.

11. A method of assembly utilizing a modularly stackable kit for providing stem, branch and foliage support for a planting, said method comprising the steps of:
providing a plurality of hoop shaped components, each exhibiting an open interior adapted to encircle and support the planting;
providing a plurality of vertically extending and elongated tier defining portions arranged in perimeter defined fashion about each of said components, an intermediate location of each of an individual plurality of said tier defining portions being integrated into each of said hoop components; and
upon supporting a lower-most hoop shaped component proximate a base of the planting, inter-engaging upper and lower ends locations of each of said elongated tier defining portions for stacking said hoop shaped components in vertically spaced apart and tiered defining fashion around the planting.

12. The method as described in claim 11, further comprising the step of providing a plurality of elongated and height extending portions interposed between each of the integrated tier defining portions in order to increase the vertical spacing between said hoop shaped components.

13. The method as described in claim 11, further comprising the step of engaging a lower-most of said hoop shaped components to an upper rim location of a planting supporting bucket.

14. The method as described in claim 11, further comprising the step of providing a plurality of feet stakes securing to lower inter engaging locations of said lower-most hoop shaped component, the feet stakes embedding in a soil location associated with a field or garden planted stem.

15. The method as described in claim 11, further comprising the step of configuring each of said upper and lower inter-engaging locations of each of said hoop integrated tier defining components with male and female end configured portions.

16. The method as described in claim 11, further comprising the step of incorporating into each of said hoop shaped components flexural properties.

17. The method as described in claim 11, further comprising the step of constructing said hoop shaped components from an injection molded thermoplastic material.

18. The method as described in claim 11, further comprising the steps of incorporating circumferentially spaced split edges into each of said hoop shaped components and of stacking said hoop shaped components so that each gap defined between each pair of split edges is either aligned with or circumferentially offset from a succeeding gap.

19. The method as described in claim 18, further comprising the step of incorporating an extending and reinforcing rib into each of said hoop shaped components further comprising an extending and reinforcing rib.

20. The method as described in claim 12, further comprising the step of configuring each of said hoop shaped components with a plurality of scalloped recessed edges in spaced apart fashion along an exterior perimeter edge and of successively stacking said hoop components so that said integrated tier defining portions are seated within an offset sub plurality of said recessed edges in a succeeding hoop shaped component in order to provider denser stacking of said components.
